(19) United States
(12) Patent Application Publication
(10) Pub. No.: US 2003/0074412 A1
(43) Pub. Date: Apr. 17, 2003

(54) Electronic mail communication system and portable terminal for the same

(75) Inventor: Takashi Muto, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/265,665

(22) Filed: Oct. 8, 2002

(30) Foreign Application Priority Data
Oct. 17, 2001 (JP) 2001-318973

(51) Int. Cl. G06F 15/16

(52) U.S. Cl. 709/206; 709/203

(57) ABSTRACT

An electronic mail communication system comprises a base station 1 and at least one portable terminal 2. A mail server 3 of the base station 1 transmits only the header portion of the electronic mail to the portable terminal 2. The portable terminal 2 receiving the header portion compares the transmitter mail address extracted from the header portion with reception target mail addresses registered in the portable terminal 2 in advance by the user. If the transmitter mail address is coincident with one of the registered reception target mail addresses, the portable terminal 2 requests the mail server 3 to transmit the mail body of the electronic mail, and if the transmitter mail address is not coincident with any registered reception target mail address, the portable terminal 2 requests the mail server 3 to delete the mail body.

### BACKGROUND OF THE INVENTION

1. Field of the Invention

The present invention relates to a system in which a portable terminal receives electronic mails from a mail server of a base station, a portable terminal using the system and a method of receiving electronic mails in the system. In more detail, the present invention relates to an electronic mail reception system in which a user of a portable terminal can select reception (download) or deletion of the mail bodies of electronic mails received by a mail server into the portable terminal without downloading the electronic mails into the portable terminal of the user, a portable terminal using the system and an electronic mail receiving method in the system.

2. Description of the Related Art

Recent compact portable information terminals have achieved dramatic breakthrough and prevalence. Particularly, cellular phones (portable telephones) have provided not only a general telephone service, but also various other services such as a web access service, an electronic mail service and an on-line commerce service, which are performed through the Internet. The cellular phones have been hitherto used mainly for voice communications, and they have been developed in order to make them available in the broadest possible range, enhance the using efficiency of electric waves and design them in compact size and light weight to enhance portability, thereby enhancing the functionality thereof.

Miniaturization of portable terminals and high-efficiency utilization of electric waves have been advanced through digitalization of the cellular system, and such an advancement is shifting the focusing point for the enhancement of functionality to the enhancement in users' convenience. Accordingly, developments as new information equipment, such as support of not only the voice communications, but also communication functions using characters, installation of various functions into portable information terminals, etc., come within sight.

Cellular phones having such information processing functions have been finally provided with a function of processing characters containing Kanji (Chinese character), and thus they have had a communication function targeting characters in addition to the traditional voice communications. This communication function means a function of creating a character message in a cellular phone and transmitting the character message to another cellular phone on the basis of a service called as “electronic mail service”.

As a service system for receiving/transmitting a character message are known two types of systems, one of which is a system of temporarily accumulating a character message and the other of which is a system of connecting one cellular phone to another cellular phone and then directly transmitting a character message. With the character message receiving/transmitting service as described above, communications under such a situation that it is difficult to utter voices can be performed, and thus such a service system has been established as one of communication means based on cellular phones.

Due to the development of such mail-function installed cellular phones and augmentation of the use (popularization) of these cellular phones, mails called as unsolicited mails such as junk mails or sales mails, and prank mails are frequently transmitted.

The present mail system for cellular phones is designed so that mail data accumulated in a mail server are collectively downloaded to a cellular phone side at the mail reception time. Accordingly, no user can check transmitters of mails addressed to him/her before the mails are actually received by the user, and thus the user cannot reject reception of undesired mails (unsolicited mails such as junk mails) before the mails are actually received.

In addition, according to some mail systems for portable terminals such as cellular phones, a user at the mail reception side must pay a communication charge for the mail reception at all times. Therefore, a disadvantage that a user must bear a communication charge for any mail addressed to the user although the mail is an undesired mail for the user has been highlighted.

As described above, the user at the reception side of the cellular phone has no means of avoiding the communication charge for undesired mails. Further, a wireless infrastructure which is a finite resource must be used even for such communications of undesired mails, and thus there occurs a disadvantage that the using efficiency of the wireless infrastructure of the mail system for cellular phones is lowered.

Therefore, one of methods to solve the above disadvantage is disclosed in Japanese Laid-open Patent Publication No. Hei-10-290255.

According to a data reception/transmission method disclosed in the above publication, when a mail server receives a mail, the mail server suggests presence of the mail to a portable terminal to which the mail is addressed, without ringing a call tone of the portable terminal, and disconnects a telephone line. If there is any access from the portable terminal, the mail server would transmit the mail. The feature of this method resides in that the mail server notifies reception of a mail to a user without putting other persons to annoyance, temporarily disconnects a telephone line and does not transmit the mail unless an access comes from the portable terminal.

However, in this method, a notification that is first transmitted from the mail server is merely a notification on the presence of a new mail, and the information on the transmitter of the mail is not notified. Accordingly, the user of the portable terminal can neither know from whom the new mail is transmitted nor know information to judge whether the new mail is an undesired mail or not before the overall content of the mail is transmitted to the user.

Japanese Laid-open Patent Publication No. Hei-10-257090 discloses a system to solve the above disadvantage.

According to the system disclosed in the above publication, a mail server stores a mail to a user of a portable terminal and stores a sender list that is set in connection with each user in advance. The mail server judges whether a sender of a mail addressed to each user is coincident with the sender list which has been already stored, and notifies reception of the mail to the portable terminal concerned only when the sender is coincident with the sender list.

However, in such a system, a user can know only the notification of reception of a mail from a sender which is registered in advance by the user, however, the user cannot know the reception situation of other mails. For example, when a mail is transmitted from a sender whom the user has forgotten to register, the reception of the mail from the sender concerned is not notified. Further, the user of the portable terminal must do a burdensome work of checking or renewing the sender list at all times.

Further, Japanese Laid-open Patent Application 2001-112058 proposes a mobile communication terminal to solve the above disadvantage.

The mobile communication terminal disclosed in the above publication has means of storing at least one of mail addresses as an address record from the headers of mails to be received/transmitted, and successively carries out address registration newly.

The mobile communication terminal disclosed in the above publication has been developed in consideration of inconvenience in operability of the portable terminal, and it merely enables address registration to be carried out in the portable terminal without imposing a burdensome work on users.

Further, a cellular phone proposed by Japanese Laid-open Patent Publication No. 2001-16364 has a function of judging whether a mail is a new mail transmitted to the cellular phone concerned or a mail to check distribution of a mail transmitted from the cellular phone concerned to another terminal. This function merely discriminates a normal mail and a check mail from each other, and it is not designed to filter out undesired mails in normal mails.

Still further, according to a mail transfer system disclosed in Japanese Laid-open Patent Publication No. Hei-2000-278311, in connection with the empty capacity of a memory of a portable terminal which receives a mail, for example, when the data capacity of a mail to be transmitted does not exceed the empty capacity of a memory of a portable terminal, the mail transfer system transmits the overall text of the mail to the portable terminal, and when the data capacity of the mail exceeds the empty capacity of the memory, the mail transfer system transmits only the header portion of the mail thus received to the portable terminal while transferring the overall mail to another accumulation terminal.

However, in the mail transfer system described above, all the mail data are transmitted to the portable terminal if the portable terminal has a margin in the memory empty capacity, and thus the portable terminal cannot necessarily always reject reception of undesired mails.

### SUMMARY OF THE INVENTION

The present invention has an object to provide an electronic mail system that can reduce wasteful communication charges based on unsolicited mails or undesired mails and reduce the load of traffic in a wireless section, a portable terminal used in the system and a method of determining whether an electronic mail should be received or not in the system.

According to a first aspect of the present invention, there is provided a portable terminal comprising: a receiving portion for receiving a header of an electronic mail from a mail server when reception processing on the electronic mail is started; and a controller for selecting either reception of the mail body of the electronic mail or deletion of the electronic mail in the mail server, on the basis of transmitter information contained in the header.

According to a second aspect of the present invention, there is provided a portable terminal comprising: a receiving portion for receiving a header of an electronic mail from a mail server when reception processing on the electronic mail is started; a storage portion for registering first transmitter information; and a controller for executing reception of the mail body of the electronic mail when second transmitter information specified on the basis of the header is coincident with the first transmitter information.

According to a third aspect of the present invention, there is provided an electronic mail communication system, comprising: a base station equipped with a mail server; and at least one portable terminal connected to the base station and equipped with a controller; wherein the mail server transmits the header of a received electronic mail addressed to the portable terminal, and the controller selects reception of the mail body of the electronic mail or deletion of the electronic mail on the basis of transmitter information contained in the header.

According to a fourth aspect of the present invention, there is provided an electronic mail communication system, comprising: a base station equipped with a mail server; and at least one portable terminal connected to the base station, and equipped with a controller and storage portion connected to the controller; wherein the mail server transmits the header of a received electronic mail addressed to the portable terminal, the storage portion registers first transmitter information and the controller executes reception of the mail body of the electronic mail when second transmitter information specified on the basis of the header is coincident with the first transmitter information.

According to a fifth aspect of the present invention, there is provided a method of determining reception or non-reception of an electronic mail in a portable terminal, comprising: a first step of receiving a header of an electronic mail when reception processing of the electronic mail is started; and a second step of selecting either reception of the mail body of the electronic mail or deletion of the electronic mail in the mail server, on the basis of transmitter information contained in the header.

According to a sixth aspect of the present invention, there is provided a method of determining reception or non-reception of an electronic mail in a portable terminal, comprising: a first step of receiving the header of the electronic mail when reception processing of the electronic mail is started; and a second step of receiving the mail body of the electronic mail when the transmitter information specified on the basis of the header is coincident with a transmitter information registered in a storage portion of the portable terminal.

### BRIEF DESCRIPTION OF THE DRAWINGS

FIG. 1 is a block diagram showing the overall construction of an electronic mail communication system according to an embodiment of the present invention;

FIG. 2 is a block diagram showing the sequence status in the processing of acquiring mail data in the electronic mail communication system according to the embodiment of the present invention;

FIGS. 3A to 3E are diagrams showing display images displayed on a display portion of a portable terminal when the mail data are acquired;

FIG. 4 is a flowchart showing the processing executed in a mail server at the base station side in the electronic mail communication system according to the embodiment of the present invention; and

FIG. 5 is a flowchart showing the processing executed at the portable terminal side performing mail reception in connection with the processing at the base station side shown in FIG. 4.

### DETAILED DESCRIPTION OF THE PREFERRED EMBODIMENTS

Preferred embodiments according to the present invention will be described hereunder with reference to the accompanying drawings.

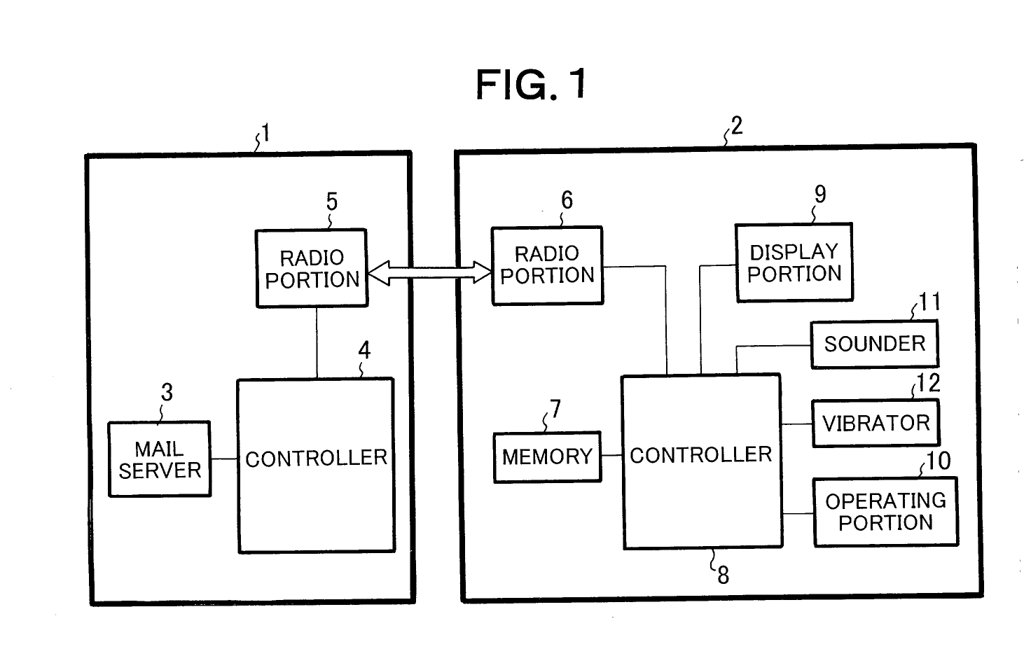

FIG. 1 is a block diagram showing the construction of an electronic mail communication system according to an embodiment of the present invention.

The electronic mail communication system of this embodiment according to the present invention includes one base station and at least one portable terminal connected to the base station. In the following description, one base station 1 and one portable terminal 2 are typically illustrated to make the present invention easy to understand.

The base station 1 has a mail server 3 for storing mails transmitted from portable terminals other than the portable terminal 2, radio portion 5 for receiving/transmitting radio signals and controller 4 for controlling the operation of the mail server 3 and the radio portion 5. Mails stored on the mail server 3 may be transmitted from personal computers through telephone lines.

The mail server 3 has a function of successively creating an unread mail list while in-coming electronic mails addressed to each of plural portable terminals are set as unread mails.

The portable terminal 2 has radio portion 6, memory (as storage portion) 7, controller 8, display portion 9, operating portion 10, sounder 11 and vibrator 12.

The radio portion 6 receives/transmits radio signals from/to the base station 1. The memory 7 stores various kinds of data such as data transmitted from the base station 1, data that are directly input by a user, etc. In this embodiment, the memory 7 stores mail addresses of transmitters whose mails are allowed to be received into the portable terminal 2 by the user (hereinafter referred to as “reception target mail addresses”).

The display portion 9 comprises a liquid crystal display device or one of other types of display devices, and it displays letters, characters and other images to the user. The operating portion 10 constitutes ten keys and other interfaces, and the user of the portable terminal 2 can input various data into the portable terminal 2 through the operating portion 10.

The sounder 11 and the vibrator 12 function to notify mail reception from the mail server 3 to the user with sound and vibration respectively, and also promote the user to input a choice when the user selects reception or non-reception of an electronic mail(s) with sound and vibration respectively as described later.

The controller 8 controls the operation of the radio portion 6, the memory 7, the display portion 9, the operating portion 10, the sounder 11 and the vibrator 12 in accordance with the transmission/reception sequence based on a protocol, for example. The controller 8 is constructed by combining CPU and peripheral circuits serving as central components with hard logic circuits such as a timer circuit.

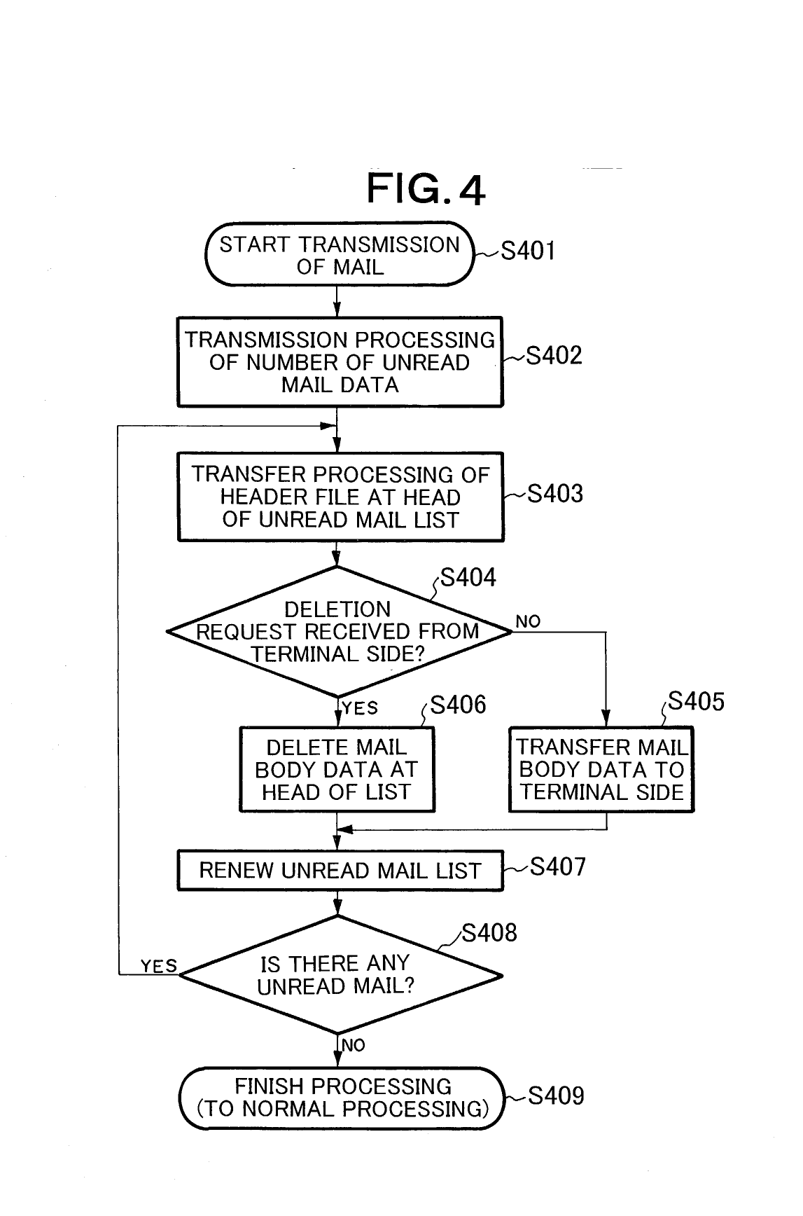

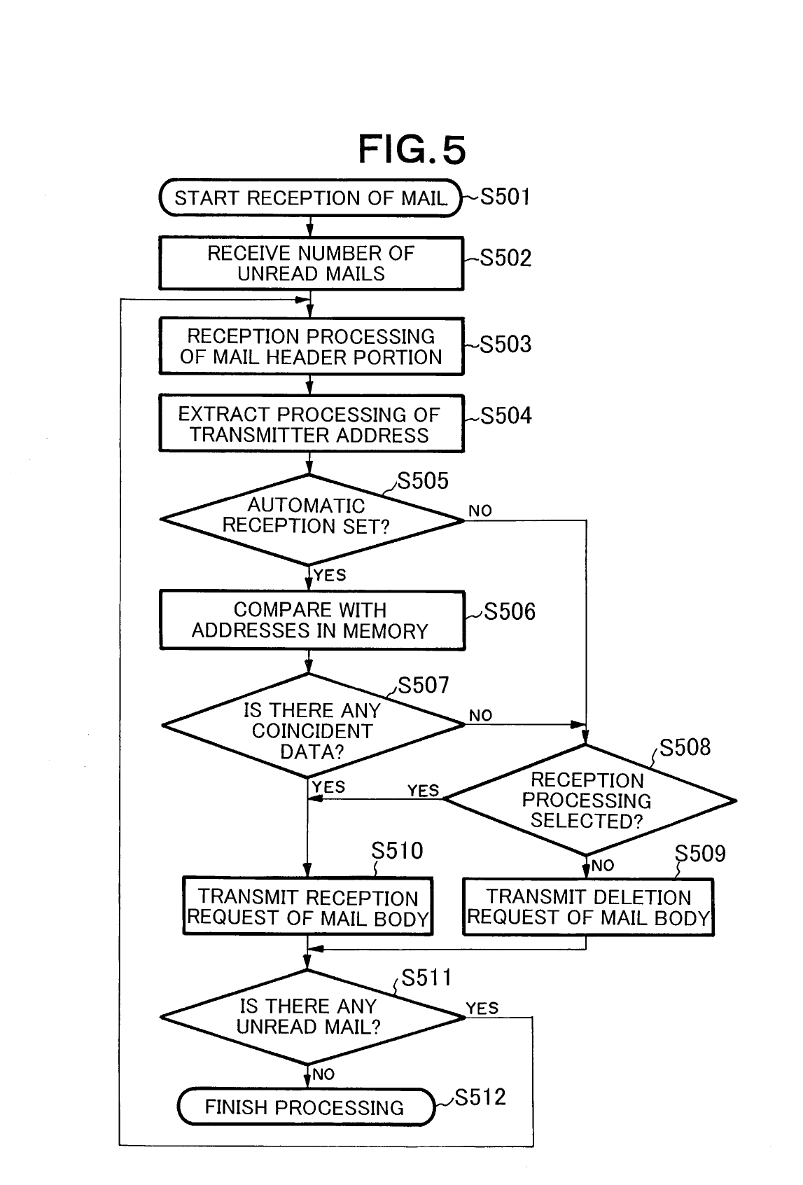

FIG. 4 is flowchart showing each step when the base station 1, particularly the mail server 3 transmits an electronic mail(s) to the portable terminal 2, and FIG. 5 is a flowchart showing each step when the portable terminal 2 receives the electronic mail(s) from the mail server 3. The operation of the electronic mail communication system according to this embodiment will be described hereunder with reference to FIGS. 4 and 5.

It is assumed that electronic mails addressed to the portable terminal 2 from other portable terminals are stored in the mail server 3. First, the mail server 3 starts the transmission processing of the electronic mails to the portable terminal 2 in step S401. The electronic mails to be transmitted from the mail server 3 are unread mails (mails that have not yet been read by the user of the portable terminal 2), and they are successively transmitted in the arrival order (that is, transmitted from a first mail which first arrived at the mail server in the mail list described above (in other words, which is the oldest mail arriving at the mail server)).

At the same time, the mail server 3 transmits the number of unread mails stored in the mail list of the mail server 3 to the portable terminal 2 in step S402.

Next, in step S403, the mail server 3 transmits only the header portion as the head data of the unread mail through the controller 4 and radio portion 5 of the base station 1 to the portable terminal 2. At the same time when the mail server 3 starts the transmission processing of the electronic mails, the portable terminal 2 starts the reception processing of the electronic mails through the radio portion 6 in step S501.

Subsequently, the portable terminal 2 receives the number of the unread mails from the mail server 3 in step S502. Thereafter, the portable terminal 2 receives the header portion as the head data of the unread mail from the mail server 3 in step S503.

Subsequently, in step S504, the controller 8 of the portable terminal 2 extracts the mail address of transmitter (hereinafter referred to as “transmitter mail addresses”) from the header portion. Usually, the header portion of each electronic mail contains a transmission source, a destination, destinations of copies, relay mail servers, the type of the mail body, a date and other data, however, the controller 8 of the portable terminal 2 extracts only the mail address of the transmission source, and only the mail address of the transmitter thus extracted is displayed on the display portion 9.

Subsequently, in step S505, the controller 8 of the portable terminal 2 judges whether the automatic reception function of electronic mails is set to “ON” or not by the user.

Here, if the automatic reception function of electronic mails is set to “ON”, the following processing is executed.

Reception target mail addresses have been registered in the memory 7 of the portable terminal 2 by the user in advance. The controller 8 successively compares the transmitter mail address extracted from each header portion with each of the reception target mail addresses every time it receives the header portion of each electronic mail.

When the transmitter mail address of an electronic mail is coincident with one of the reception target mail addresses, the controller 8 automatically transmits a transmission request for transmitting the mail body of the electronic mail concerned to the mail server 3. In response to this request, the mail server 3 transmits the data of the mail body of the electronic mail to the portable terminal 2.

When the transmitter mail address is not coincident with any reception target mail address, a request for deleting the data of the mail body of the electronic mail concerned may be automatically transmitted to the mail server 3, or the user may be allowed to judge on the display portion 9 of the portable terminal 2 whether the electronic mail concerned should be received or not. The specific processing at this stage will be described later.

When the electronic-mail automatic reception function is not set to “ON” (that is, it is set to “OFF”) (“No”: step S505), on the basis of the transmitter mail address thus received, the user of the portable terminal 2 selects reception or non-reception of the electronic mail in step S508. At this stage, the portable terminal 2 actuates one or both of the sounder 11 and the vibrator 12 so as to promote the user to selectively input his/her choice (reception or non-reception).

When the user selects “reception” (“Yes”: step S508), in step S510, the portable terminal 2 requests the mail server 3 of the base station 1 to transmit the mail body of the electronic mail corresponding to the header portion which has been already transmitted.

When the user selects “non-reception” (“No”: step S508), in step S509, the portable terminal 2 requests the mail server 3 of the base station 1 to delete the mail body of the electronic mail corresponding to the header portion which has been already transmitted.

In response to the selection of mail reception or mail deletion from the user in the steps S509 and 508, the mail server 3 judges in step S404 whether the portable terminal 2 requests the deletion of the mail body of the electronic mail.

When the mail server 3 judges that the user of the portable terminal 2 requests the transmission of the mail body of the electronic mail (“No”: step S404), the mail server 3 starts to transmit the mail body of the electronic mail concerned to the portable terminal 2 in step S405.

On the other hand, when the mail server 3 judges that the user of the portable terminal 2 requests the deletion of the mail body of the electronic mail (“YES”: step S404), the mail server 3 deletes the overall data of the mail body of the electronic mail concerned in step S406.

When the electronic mail transmission processing in step S404 or the data deletion processing of the mail body of the electronic mail in step S406 is completed, the mail server 3 renews the unread mail list which is created with respect to the portable terminal 2 in step S407.

Subsequently, the mail server 3 judges in step S408 whether any unread mail exists.

If the mail server 3 judges that any unread mail exists (“YES”: step S408), it repeats the processing from the step S402 to the step S407 described above until no unread mail exists in the mail server 3, and then finishes the processing when there is no unread mail, in step S409.

If the mail server 3 judges that there exists no unread mail (“No”: step S408), the processing of the mail server 3 is finished.

The portable terminal 2 judges in step S511 whether there exists any unread mail after it requests transmission of the mail body of the electronic mail (step S509) or deletion of the mail body of the electronic mail (step S510) to the mail server 3.

If there exists no unread mail (“No”: step S511), the whole processing at the portable terminal side is finished. On the other hand, if there exists any unread mail (“YES”: step S511), the processing from the step S502 to the step S509 or step S510 is repeated. This processing is repeated until there exists no unread mail, and finally in step S512, when there exists no unread mail, the processing is finished.

When the electronic-mail automatic reception function is not set to “ON” (“NO”: step S505), the processing is carried out as described above.

On the other hand, when the electronic-mail automatic reception function is set to “ON” (“YES”: step S505), the controller 8 compares each of the reception target mail addresses registered in the memory 7 of the portable terminal 2 with the transmitter mail address extracted from the header portion (step S506), and judges whether both are coincident with each other (step S507).

If the transmitter mail address is coincident with one of the reception target mail addresses (“YES”: step S507), the controller 8 automatically transmits a transmission request for the mail body of the electronic mail to the mail server 3 (step S510).

In response to this request, the mail server 3 transmits the data of the mail body of the electronic mail to the portable terminal 2 (step S405). The subsequent processing are the same as described above.

If the transmitter mail address is not coincident with any reception target mail address (“NO”: step S507), the portable terminal 2 displays this fact on the display portion 9, and requests the user to judge whether the corresponding electronic mail should be received or not (step S508). The processing of the steps S509, S510 and S511 subsequent to the step S508 are carried out as described above.

Here, the processing of the steps S505, S506 and S507 at the portable terminal 2 side are carried out independently of the mail server 3.

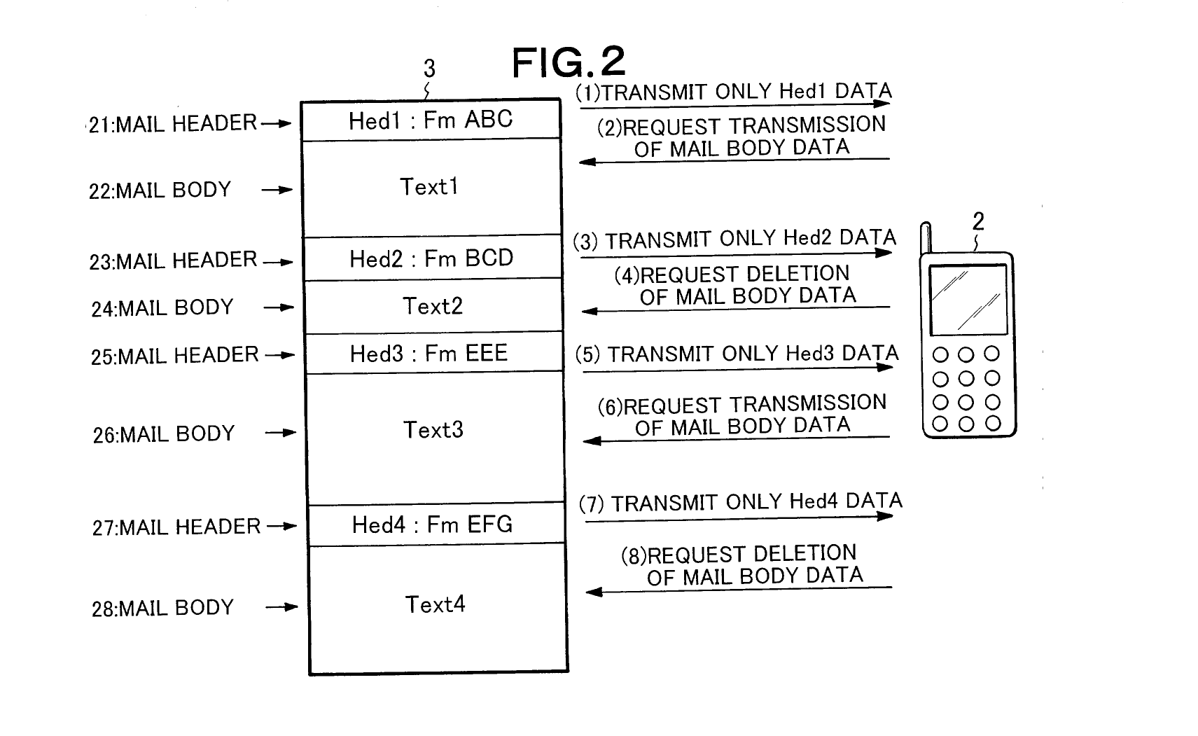

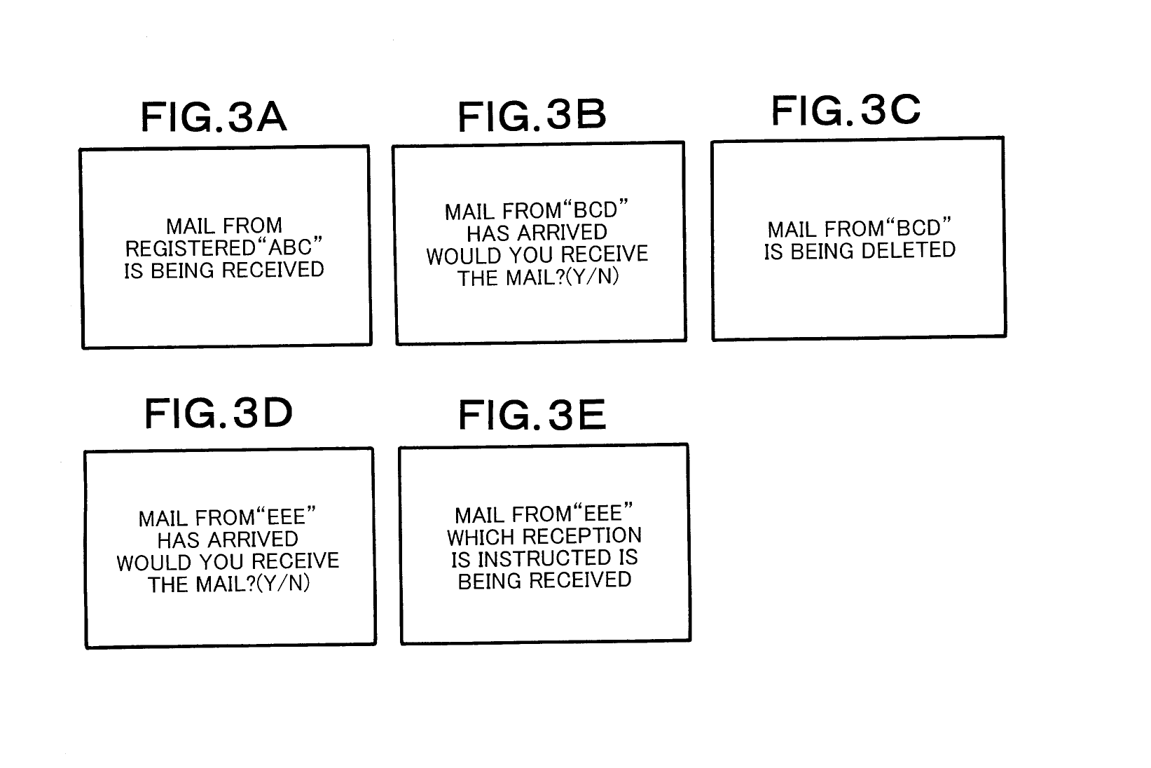

Next, the corresponding relationship between the sequence of electronic mail data and the display on the display portion 9 of the portable terminal 2 when electronic mail data are acquired will be described with reference to FIGS. 2 and 3.

FIG. 2 is a diagram showing the electronic mail data sequence in the electronic mail data reception processing and FIG. 3 is a diagram showing a display image (frame) displayed on the display portion 9 of the portable terminal 2 in connection with the electronic mail data sequence.

It is assumed that electronic mail data from transmitters ABC, BCD, EEE and EFG have been stored in the unread mail list of the mail server 3 in the order from the oldest mail to the latest mail (that is, in the reception (arrival) order) as shown in FIG. 2. In this embodiment, it is assumed that the mail address of the transmitter ABC (corresponding to a mail reception target) has been already registered as a reception target mail address in the memory 7 of the portable terminal 2.

Mail header 21 is the header portion (“Hed 1” of FIG. 2) of the mail data from the transmitter ABC, and mail body 22 is the text body (“Text 1” of FIG. 2) corresponding to the mail header 21. Mail header 23 is the header portion (“Hed 2” of FIG. 2) of the mail data from the transmitter BCD, and mail body 24 is the text body (“Text 2” of FIG. 2) corresponding to the mail header 23. Mail header 25 is the header portion (“Hed 3” of FIG. 2) of the mail data from the transmitter EEE, and mail body 26 is the text body (“Text 3” of FIG. 2) corresponding to the mail header 25. Likewise, mail header 27 is the header portion (“Hed 4” of FIG. 2) of the mail data from the transmitter EFG, and mail body 28 is the text body (“Text 4” of FIG. 2) corresponding to the mail header 27.

First, the mail header 21 is transmitted to the portable terminal 2. The mail address of the transmission source is extracted from the mail header 21 at the portable terminal 2, and the mail address (transmitter mail address) of the mail header 21 thus extracted is compared with each of the reception target mail addresses registered in the memory 7.

As described above, since the mail address of the transmitter ABC has been registered in the memory 7, a mail reception request, that is, a transfer request for the mail body 22 is automatically transmitted from the portable terminal 2 to the mail server 3. In response to this request, the mail body 22 is transferred from the mail server 3 to the portable terminal 2. FIG. 3A shows a display image on the display portion 9 when the mail body is transferred to and received by the portable terminal 2 as described above.

After the above processing is finished, the mail header 23 is transmitted from the mail server 3 to the portable terminal 2. In the portable terminal 2, the mail address of the mail header 23 (transmitter mail address) is compared with each of the reception target mail addresses registered in the memory by the mail automatic reception setting function. In this case, since the mail address of the transmitter BCD is not registered, a display image shown in FIG. 3B is displayed on the display portion 9 of the portable terminal 2.

In this case, when the user of the portable terminal 2 rejects reception of the mail body of the corresponding electronic mail, the user selects “N”, so that a request for deleting the mail body 24 corresponding to the mail header 23 is transmitted from the portable terminal 2 to the mail server 3.

In response to this request, the mail server 3 deletes the mail body 24, that is, the text body “Text 2” of FIG. 2. When the text body “Text 2” is deleted, a display image shown in FIG. 3C is displayed.

Subsequently, when the mail header 25 is transmitted to the portable terminal 2, the display portion 9 of the portable terminal 2 displays a display image shown in FIG. 3D. In this case, when the user of the portable terminal 2 wants to receive the mail body of the electronic mail (the electronic mail from the transmitter EEE), the user selects “Y”. Accordingly, the mail body 26 corresponding to the mail header 25 is transferred from the mail server 3 to the portable terminal 2. A display image shown in FIG. 3E is displayed on the display portion 9 of the portable terminal 2 while the portable terminal 2 receives the mail body 26.

Likewise, the mail header 27 is transmitted to the portable terminal 2, and when the user rejects reception of the mail, the mail server 3 deletes the mail body 28, that is, the text body “Text 4” of FIG. 2 on the basis of the deletion request from the portable terminal 2. As shown in FIG. 2, the text body “Text 2” and the text body “Text 4” in the data list are deleted, and thus the corresponding areas of the data list are set to empty states.

As described above, the data of the text bodies “Text 2” and “Text 4” are not transmitted to the portable terminal 2, so that the communication charges corresponding to the communication of these data can be saved and the wasteful traffic in the radio section can be reduced.

The display images of the display portion 9 of the portable terminal 2 shown in FIG. 3 are examples, and icons or other type display modes may be used.

According to the embodiment, only the header portion is transmitted from the mail server to the portable terminal, and the user can know only the mail address of the transmitter on the basis of the mail header portion. Therefore, the user can reject reception of the mail bodies of the undesired electronic mails such as unsolicited mails, junk mails, etc. That is, the user of the portable terminal can select reception or non-reception of any electronic mail body. Therefore, the user can receive only desired mails, so that the data amount to be communicated can be reduced and the users of portable terminals can reduce the communication charges imposed on them. Further, there can be avoided such a situation that the finite resource in the radio section is wasted. This is very beneficial from the social viewpoint.

Still further, the judgment as to whether it is necessary or unnecessary to receive an electronic mail is not made by displaying only titles, but on the basis of the transmitter mail addresses. Therefore, it can be avoided to determined reception or non-reception of electronic mails on the basis of only the titles of the electronic mails. Accordingly, the toll of the radio infrastructure for regularly-used electronic mails can be secured.

What is claimed is:

1. A portable terminal comprising:
a receiving portion for receiving a header of an electronic mail from a mail server when reception processing on the electronic mail is started; and
a controller for selecting either reception of the mail body of the electronic mail or deletion of the electronic mail in said mail server, on the basis of transmitter information contained in the header.

2. A portable terminal comprising:
a receiving portion for receiving a header of an electronic mail from a mail server when reception processing on the electronic mail is started;
a storage portion for registering first transmitter information; and
a controller for executing reception of the mail body of the electronic mail when second transmitter information specified on the basis of the header is coincident with the first transmitter information.

3. The portable terminal as claimed in claim 2, wherein said controller requests said mail server to delete the mail body of the electronic mail when the second transmitter information is not coincident with the first transmitter information.

4. The portable terminal as claimed in claim 2, further comprising an operating portion for inputting data by a user of said portable terminal, the data being sent to said controller,
wherein the user input to said operating portion data for selecting either reception of the main body of the electronic mail or deletion of the electronic mail in said mail server when the second transmitter information is not coincident with the first transmitter information.

5. An electronic mail communication system, comprising:
a base station equipped with a mail server; and
at least one portable terminal connected to said base station and equipped with a controller;
wherein said mail server transmits a header of a received electronic mail addressed to said portable terminal, and said controller selects reception of the mail body of the electronic mail or deletion of the electronic mail in said mail server on the basis of transmitter information contained in the header.

6. An electronic mail communication system, comprising:
a base station equipped with a mail server; and
at least one portable terminal connected to said base station, and equipped with a controller and storage portion connected to said controller;
wherein said mail server transmits a header of a received electronic mail addressed to said portable terminal, said storage portion registers first transmitter information and said controller executes reception of the mail body of the electronic mail when second transmitter information specified on the basis of the header is coincident with the first transmitter information.

7. The electronic mail communication system as claimed in claim 6, wherein said portable terminal requests said mail server to delete the mail body of the electronic mail when the second transmitter information is not coincident with the first transmitter information.

8. The electronic mail communication system as claimed in claim 6, said portable terminal further comprising an operating portion for inputting data by a user of said portable terminal, the data being sent to said controller,
wherein the user inputs to said operating portion data for selecting either reception of the main body of the electronic mail or deletion of the electronic mail in said mail server when the second transmitter information is not coincident with the first transmitter information.

9. A method of determining reception or non-reception of an electronic mail in a portable terminal, comprising:
a first step of receiving a header of an electronic mail when reception processing of the electronic mail is started; and
a second step of selecting either reception of the mail body of the electronic mail or deletion of the electronic mail in said mail server, on the basis of transmitter information contained in the header.

10. A method of determining reception or non-reception of an electronic mail in a portable terminal, comprising:
a first step of receiving the header of the electronic mail when reception processing of the electronic mail is started; and
a second step of receiving the mail body of the electronic mail when the transmitter information specified on the basis of the header is coincident with a transmitter information registered in a storage portion of the portable terminal.

11. The method as claimed in claim 10, further comprising a third step of requesting a mail server to delete the mail body of the electronic mail when the transmitter specified on the basis of the header is not coincident with any transmitter registered in the storage portion.

12. The method as claimed in claim 10, further comprising a fourth step of selecting reception of the mail body of the electronic mail or deletion of the electronic mail in said mail server when the transmitter information specified on the basis of the header is not coincident with any transmitter information registered in the storage portion.
